(19) United States
(12) Patent Application Publication
(10) Pub. No.: US 2014/0132877 A1
(43) Pub. Date: May 15, 2014

(54) LIQUID CRYSTAL DISPLAY, AND CONFIGURATION THEREOF

(71) Applicant: WESTINGHOUSE DIGITAL, LLC, Orange, CA (US)

(72) Inventors: Yong-Yung Tsao, Norwalk, CA (US); John K. Araki, Tustin, CA (US)

(73) Assignee: Westinghouse Digital, LLC, Orange, CA (US)

(21) Appl. No.: 13/675,323

(22) Filed: Nov. 13, 2012

(51) Int. Cl. G02F 1/1333

(52) U.S. Cl. CPC G02F 1/1333
USPC 349/58

(57) ABSTRACT

A liquid crystal display (LCD) includes a frame, components that are supported by the frame, and a rear cover that forms at least part of a back side of the display. The rear cover has a configuration that allows the same general layout to be used with a variety of sizes of LCDs. It may have a rectangular shape that does not extend to an outer periphery of the LCD. The rear cover may serve as a structural support that prevents bending of components of the LCD, and may have strengthening ribs toward achieving that end. The components of the LCD may be supported by the frame.

### BACKGROUND OF THE INVENTION

1. Field of the Invention

The invention is in the general field of display devices and configurations, and more particularly liquid crystal display devices and configurations.

2. Description of the Related Art

A variety of sizes, types, and configurations of video displays have been used. One type of display is the liquid crystal display (LCD), a flat-panel display that uses liquid crystals to act as light valves on a backlight to modulate illumination and generate images. LCDs have gained popularity for their low cost, good performance, light weight, and long life, among other factors.

Improvements in displays, both in reducing manufacturing costs and improving appeal to consumers, are always desirable. There are continuous research efforts for minimizing (slimming) the thicknesses of LCDs, and for developing designs with enhanced attractive appearance. In these research and development efforts, traditional principles of LCD device design have presented limitations in slimming display devices and developing new display device designs.

### SUMMARY OF THE INVENTION

According to an aspect of the invention, a liquid crystal display (LCD) has a configuration that can be easily adapted to LCDs of various sizes. The versatility leads to efficiencies in manufacturing different sizes of LCDs.

According to another aspect of the invention, an LCD relies for structural support on a rear cover with strengthening ribs.

According to yet another aspect of the invention, an LCD has a rear cover that provides support against bending, and is mostly uncovered.

According to still another aspect of the invention, an LCD has a metal or engineering plastic rear cover that provides structural support, in addition to providing a durable metal or plastic exterior surface.

According to an aspect of the invention, a liquid crystal display (LCD) includes: a frame; components of the LCD that are supported by the frame; and a rear cover that forms at least part of a back side of the LCD. At least some of the components are coupled to an inside surface of the frame. The LCD has a rectangular shape, with a rectangular front face and a rear face. The LCD has an exterior surface that defines an outer periphery of the rectangular shape, between the front face and the rear face. The rear cover is in an interior part of the rectangular shape, such that the exterior surface does not include any part of the rear cover.

According to another aspect of the invention, a liquid crystal display (LCD) includes: a frame; components of the LCD that are supported by the frame; and a rear cover that forms at least part of a back side of the LCD. The rear cover includes a center portion, and two side portions on opposite sides of the central portion. The rear cover is a structural support that prevents bending of the components. The rear cover includes strengthening ribs. Desirably, the components include a cell and backlight unit of an LCD module, and the rear cover comprises a cover of the LCD module that also serves as rear cover of the LCD.

According to yet another aspect of the invention, a liquid crystal display (LCD) includes a frame; components of the LCD that are supported by the frame; and a rear cover that forms at least part of a back side of the LCD. The rear cover includes a center portion, and two side portions on opposite sides of the central portion. The rear cover is a structural support that prevents bending of the components. The side portions are substantially uncovered, and therefore part of an exterior rear surface of the LCD. Desirably, the components include a cell and backlight unit of an LCD module, and the rear cover comprises a cover of the LCD module that also serves as rear cover of the LCD.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Annexed are drawings depicting one or more embodiments of the invention. The drawings are not necessarily to scale.

FIG. 1 is a perspective view showing the front of a liquid crystal display (LCD) in accordance with an embodiment of the invention.

FIG. 2 is another perspective view, showing the back of the LCD of FIG. 1.

FIG. 3 is a side view of the LCD of FIG. 1.

FIG. 4 is an exploded view of some of the parts of the LCD of FIG. 1.

FIG. 5 is a side view at a top of the LCD of FIG. 1.

FIG. 6 is a sectional view showing the configuration of the parts of the LCD of FIG. 1, at a top of the LCD.

FIG. 7 is a sectional view showing the configuration of the parts of the LCD of FIG. 1, at a bottom of the LCD.

FIG. 8 is a back view of an LCD in accordance with a first alternate embodiment of the invention.

FIG. 9 is a back view of an LCD in accordance with a second alternate embodiment of the invention.

FIG. 10 is a back view of an LCD in accordance with a third alternate embodiment of the invention.

FIG. 11 is a back view of an LCD in accordance with a fourth alternate embodiment of the invention.

### DETAILED DESCRIPTION

As used in the present application, a liquid crystal display (also herein LCD, or LCD device) is a complete display product that incorporates a liquid crystal display module (also herein LCD module, or module) as a principal component. The complete LCD includes the module as well additional components such as front and rear covers, control electronics, input switches and connectors for the control electronics, speakers, stand or wall mount hardware, etc. For example, LCD devices having a diagonal size (screen size) of 20 inches and larger are used as medium to large sized display products such as televisions and computer monitors. In typical LCD manufacture, one company or manufacturing operation assembles or builds the LCD module, and another company or manufacturing operation assembles the LCD module with the other components into a complete LCD.

The LCD module includes a fabricated glass panel (cell, or LCD panel), a backlight unit, a support housing or frame, and additional components such as driver integrated circuits, needed to create a finished LCD display panel.

A cell is a fabricated glass panel having display pixels; the cell receives light from the backlight unit and either blocks the light (black) or transmits the light (white) at given display pixels. One type of driver integrated circuitry for a cell is chip on flex (COF) circuitry, an LCD driver chip mounted on a flexible circuit that is attached to the contact edge of the cell. COF circuitry is commonly used in LCD panels having a diagonal size of 20 inches or more. Open-cell panels are LCD panels that have not yet been assembled into a module. For example, one company or manufacturing operation may build the cell, and another may assemble the cell into an LCD module.

A backlight unit or backlight is the light source for an LCD panel or cell. In medium to large sized LCD devices, the backlight unit typically is located directly behind the cell. Types of backlight units commonly used in medium to large sized LCD devices include backlights with cold-cathode fluorescent lamps (CCFLs) as light sources; full-array LED backlights in which the light sources are rows of LEDs spread across the backlight directly behind the LCD panel; and edge-lit backlights in which the light source (LED or CCFL) is on the edge of the backlight unit rather than directly behind the LCD panel.

A frame is a frame-shaped structure that surrounds the active components of the LCD module. The frame protects the edges of the cell, the backlight unit, and any circuitry that may be located there. The cell and backlight unit form a sandwich, which can be held together at the edges by the frame and/or by additional hardware such as C-clamps. The module also includes a rear panel cover, which supports the active components of the module and covers the rear surface of these components. The rear panel cover comprises a rigid material, and may include reinforcing structures such as ribs, to limit bending and avoid failure of the cell. The frame acts as a holder for the cell and backlight unit and should have compatible dimensions with these module components; the frame does not need to be rigid since the rear panel cover provides rigid support of the module components.

In traditional LCD design, the LCD module housing structures including the frame and the rear panel cover are not intended to serve as exterior structures of the LCD, but rather to provide mechanical reliability of the module. The frame and rear cover of the LCD module are designed to mount and support other components of the LCD such as front and rear covers, control circuitry, speakers, etc. The frame and rear cover of the LCD module generally include mounting and fastening mechanisms such as stand-offs, through holes for fasteners, clips, etc. for attaching the other components of the LCD. The outer casing (front and rear covers) of the fully assembled LCD typically includes a front bezel, a border structure that surrounds the viewable area at the front of the LCD device and that may extend around outer edges of the LCD. The outer casing of the LCD also typically includes a rear device cover mounted over the rear panel cover and over other components at the back of the LCD, such as the control electronics.

LCDs of the present invention do not follow these traditional rules of design and manufacture of LCD modules and of fully assembled LCDs. Improved designs of the frame and rear panel cover (herein called rear cover) of the LCD serve to support and protect active components of the LCD module, but the LCD does not include additional covering structures at rear and outer edge surfaces of the fully assembled LCD. In an advantageous embodiment, the frame and the rear cover serve as exterior structures of the LCD device, providing a slimmer, attractive appearance of the LCD. Furthermore, the improved LCD design reduces the number of parts, such as the number of fasteners used to attach additional LCD components to the LCD module, and simplifies assembly of the LCD.

A liquid crystal display (LCD) in accordance with the invention includes a frame, components that are supported by the frame, and a rear cover that forms at least part of a back side of the display. The rear cover has a configuration that allows the same general layout to be used with a variety of sizes of LCDs. It may have a rectangular shape that does not extend to an outer periphery of the LCD. The rear cover of the LCD also serves as the rear cover for the LCD module. The rear cover protects and prevents bending of components of the LCD module, and preferably includes strengthening ribs for that purpose. In an advantageous embodiment, these strengthening ribs are elements of an attractive design of the rear of the LCD.

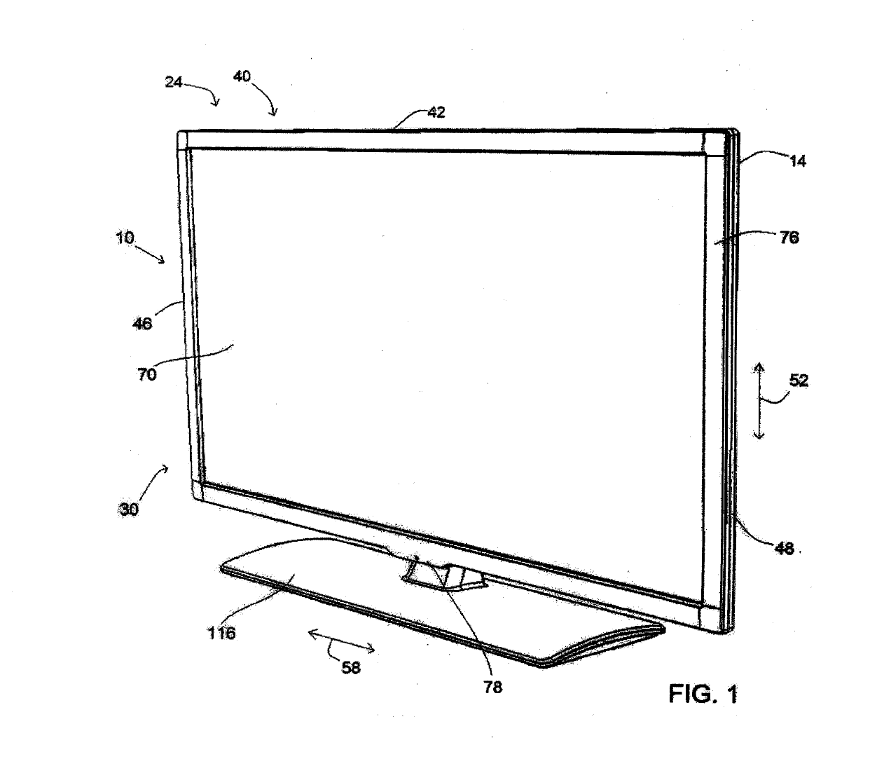

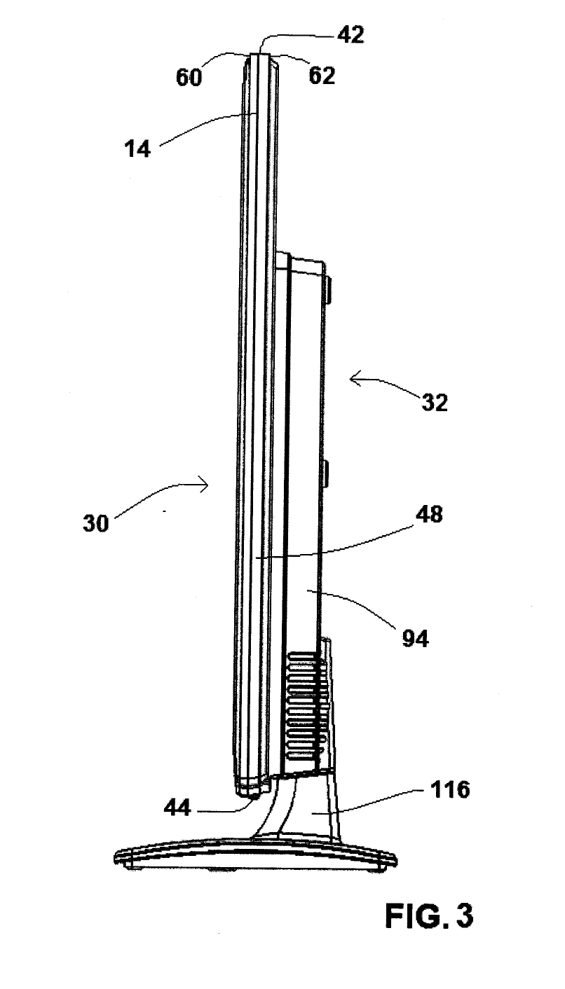

FIGS. 1-5 show a liquid crystal display (LCD) 10 that includes components 12 supported by a frame 14. A rear cover 16 covers part of a back surface of the components 12.

The LCD 10 has a polygonal shape, which in the illustrated embodiment is a rectangular shape. The term “rectangular shape” is used here in to refer to a shape having generally straight sides, although the outer periphery of the rectangular shape may have protrusions and/or recesses, without departing from this definition of a rectangular shape. The rectangular-shape LCD 10 defines an outer periphery 24, along the outer faces of the LCD 10, the faces including a front major surface (front side or face) 30 and a rear major surface (rear side or face) 32 of the LCD 10.

The outer periphery 24 is an exterior surface 40 of the LCD 10 that includes a top exterior surface portion 42, a bottom exterior surface portion 44, and a pair of side exterior surface portions 46 and 48. The top exterior surface portion 42 and the bottom exterior surface portion 44 are on opposite respective sides of the liquid crystal display 10 in a first direction 52. The side exterior surface portions 46 and 48 are on opposite respective sides of the liquid crystal display 10 in a second direction 56. The exterior surface 40 has a front edge 60 at the intersection of the exterior surface 40 and the front face 30, and a rear edge 62 at the intersection of the exterior surface 40 and the rear face 32.

The frame 14 may constitute at least part of the front edge 60, for example constituting substantially all of the front edge 60. The frame 14 may alternatively or also constitute at least part of the rear edge 62, for example constituting substantially all of the rear edge 62.

In the preferred embodiment, the frame 14 forms part of the external surface of the LCD 10, when the LCD 10 is fully assembled. In this embodiment, the frame 14 forms all of or a substantial portion of the top exterior surface portion 42; the frame forms all or a substantial portion of the side exterior surface portions 46 and 48 of the LCD; and the frame forms a more limited portion of the bottom exterior surface portion 44 of the LCD.

The components 12 include the active components of an LCD module including a cell 70 that has display pixels, and a backlight unit 72 that provides light to produce (in conjunction with the cell 70) an image on the LCD 10. The structures, functions, and interrelationship of the cell 70 and the backlight unit 72 are conventional, as briefly described above.

The LCD 10 also includes a bezel (or front bezel) 76. The bezel 76 may constitute at least part of the front face 30 of the LCD, surrounding a viewing surface of the cell 70. The bezel 76 may constitute at least part of the front edge 60, for example constituting less than half of the front edge 60. As described in greater detail below, the bezel 76 may be mounted to an inside surface of the frame 14.

The rear cover 16 includes most of the back face 32 of the LCD 10. The rear cover 16 includes a center portion 82, and a pair of side portions 84 and 86 that flank the central portion. The center portion 82 supports a main board housing 90 that includes circuitry for controlling the LCD 10. The center portion 82 may have a width corresponding to (or slightly greater than) the width of the main board housing 90. For medium to large size LCDs having a diagonal size of 20 inches or greater, an exemplary width of center portion 82 is 12 inches, but this width is not critical and can be increased or decreased depending on the width of the main board housing 90 or desired appearance of the back face 32 of LCD 10. The center portion 82 may have a width between about 20% to 60% of an overall combined width of the center portion 82 and the side portions 84 and 86.

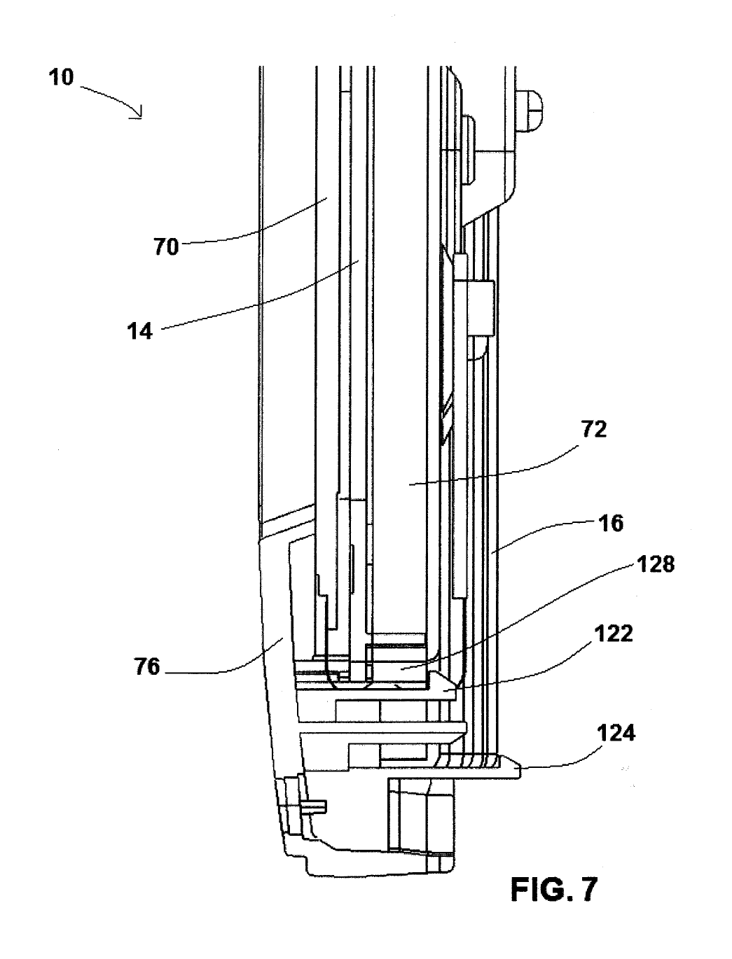

The side portions 84 and 86 are located at opposite sides of the main board housing 90. In one embodiment, a standard sized main board housing 90 is used with LCDs 10 having different screen sizes. In this case, the width of the center portion 82 is the same for the different size LCDs 10, but the widths of the side portions 84 and 86 is greater or smaller depending on the size of LCD 10. The side portions 84 and 86 may be bilaterally symmetric on opposite sides of the center portion 82. The side portions 84 and 86 may be substantially uncovered, and therefore part of the exterior rear surface of the LCD 10. As substantially uncovered is used in this patent application, where less than 20% of the side portions are covered with components such as the speakers 244, 246 shown in FIG. 7, the side portions shall be considered substantially uncovered.

The circuitry of the main board housing 90 includes conventional circuitry for processing received video and audio signals, and for controlling functions of the LCD 10. The circuitry may be embodied in one or more integrated circuit boards, or other suitable electronic structures. The circuitry may also have any of a variety of other conventional electrical components, such as power circuitry.

The main board housing 90 is connected to a back face 92 of the center portion 82, the face of the center portion 82 that faces away from the components 16. A main board housing cover 94 covers the main board housing 90. The main board housing cover 94 also covers at least part of the center portion 82. The main board housing cover 94 may have connectors (not shown) along its sides, top, bottom, and/or back face, for connecting other devices to the LCD 10.

The rear cover 16 may include strengthening ribs that provide additional structural support, for example by increasing the resistance of the rear cover 16 to bending. The ribs may include horizontal ribs, such as the rib 100, and/or vertical ribs 102 and 104. The vertical ribs 102 and 104 may be located at boundaries between the center portion 82 and the side portions 84 and 86. A wide variety of other rib configurations are possible. Diagonal ribs also may be used. The reinforcing ribs may have smooth, continuous outer surfaces, and rounded edges, to provide a more attractive appearance of rear cover 16, as well as providing functional benefits, such as a better surface for gripping or pressing on with a hand.

The LCD 10 may have speakers 110 and 112, for providing audio output. The speakers 110 and 112 are below the main board housing 90, coupled to the center portion 82. A speaker cover 114 may cover the speakers 110 and 112. Alternatively the speakers 110 and 112 may be connected to the side portions 84 and 86 of the rear cover 16.

The LCD 10 may include a stand 116 that provides a base for placing the LCD 10 on a table or other horizontal surface. The stand 116 may be attached to the speaker cover 114. Alternatively the stand 116 may be connected to other parts of the LCD 10.

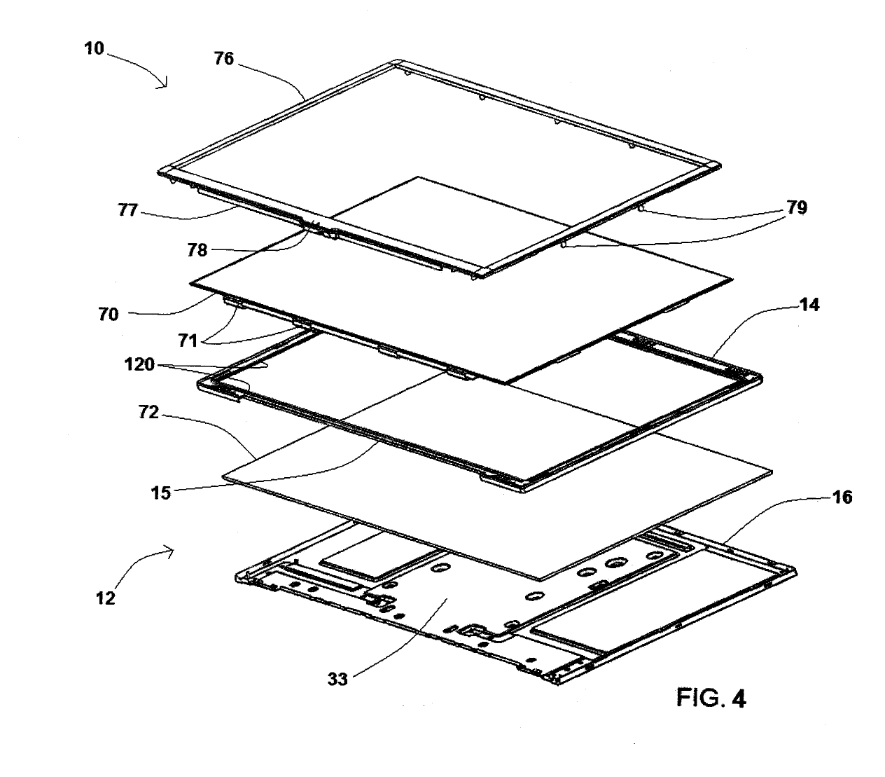

In the exploded view of FIG. 4, various components 12 of LCD 10 are oriented so that the bottom edges of these components face toward the lower left in this view and the front faces of these components face upward. The rear surface of the bezel 76 (facing downward in this view) may include structures such as mounting posts 79 to couple the bezel within an interior recess 120 of frame 14. Similarly, the rear cover 16 may include outer edge portions and associated mechanisms configured to couple the rear cover 16 within the recess of frame 120. The frame 14 also holds other components 12 such as cell 70, chip on flex (COF) circuits 71 at the edge of cell 70, and backlight unit 72. The LED 10 may include hardware such as C-clamps (not shown) to clamp the cell 70 against backlight unit 72 within frame 14, or the cell and backlight unit may be pressed together by the frame 14.

A substantial portion 15 of the bottom outer edge of frame 14 may be cut away; this cut-away edge portion of frame 14 to makes room for components of the LCD module (such as a source board, not shown) located hear the bottom outer edge of the module. The bottom edge of bezel 76 may include portions 77 that extend beyond the bezel front face. These bezel portions 76 wrap around the bottom exterior surface portion 44 of the LCD in lieu of the cut-away area 15 of frame 14, and cover the components 12 where the frame 14 is cut away. The bezel 76 may include an extended region or lip 78 at the bottom center of the front of the LCD 10 that can encapsulate an infrared or other sensor for receiving signals through a hole in the bezel 76. The LCD may include other components at lip 78 such as a power switch, and timing controller (TCON) (not shown). The bottom edge configurations of the frame 14 and bezel 76 shown in FIG. 4 are illustrative of one arrangement, and alternative configurations may be provided depending, e.g., on the locations and configurations of other components 16 adjacent the bottom edge of LCD 10.

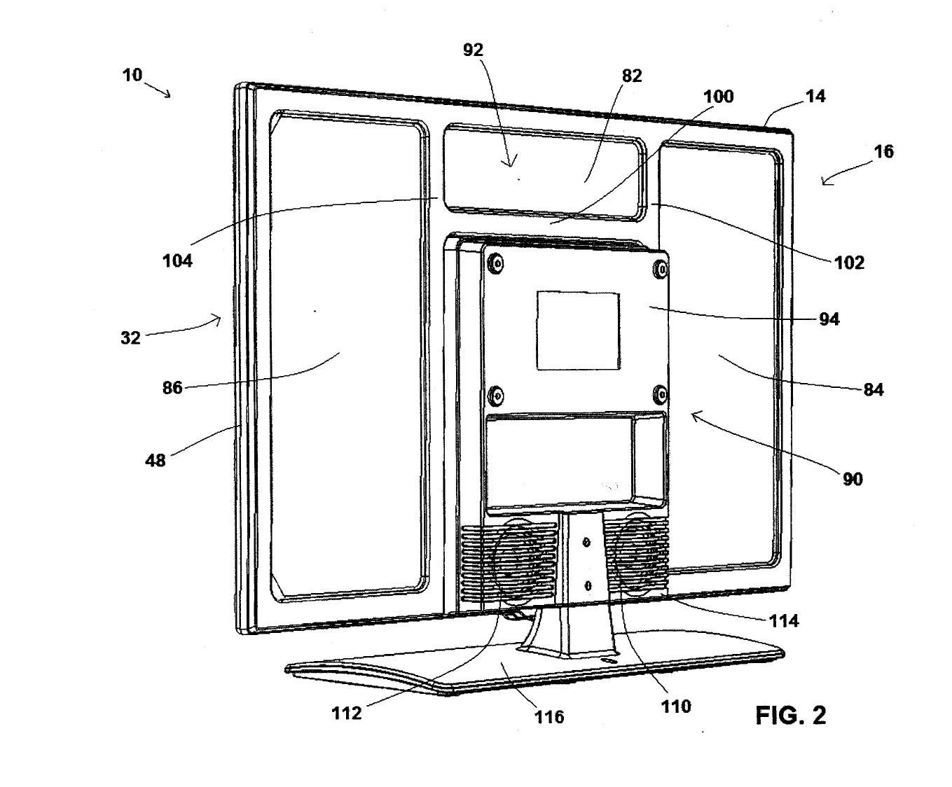

The inner face 33 of rear cover 16, a portion of which is seen in FIG. 4, includes fastening and mounting mechanisms to engage and support interior components 12 of the LCD 10. In comparison, the rear face 32 of rear cover 16 (FIG. 2), has an attractive appearance with a limited number of mechanisms such as stand-offs and fasteners (not shown) to support components like the main board housing 90.

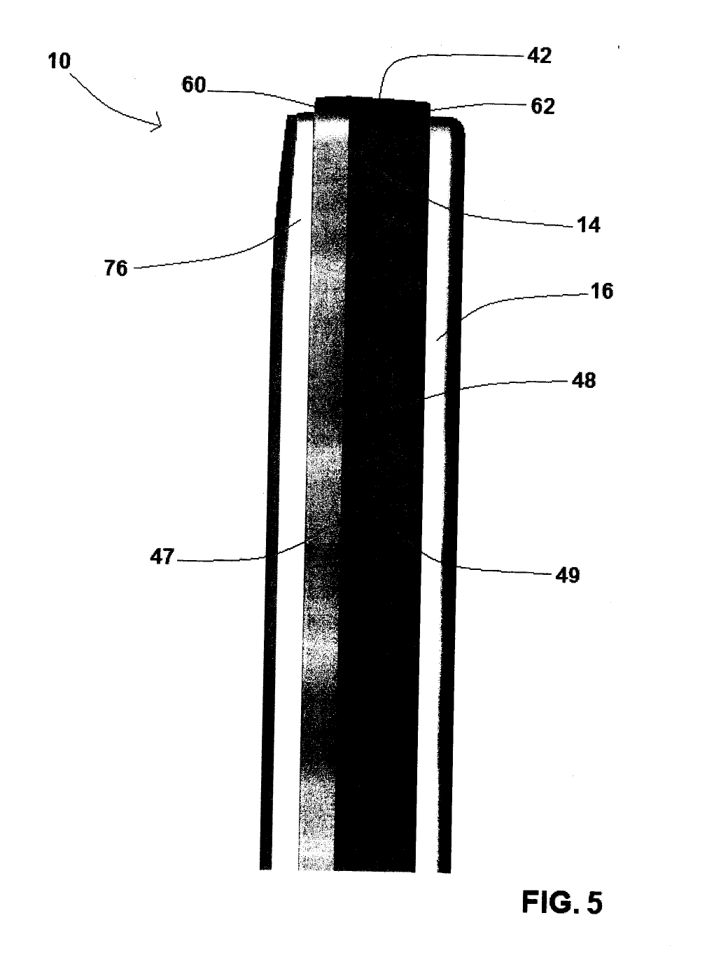

FIG. 5 is a close-up side view of the LCD 10, including the frame 14, rear cover 16, and bezel 76. The frame has an attractive appearance, with smooth surfaces and rounded edges, for example of the side exterior surface portion 48 and top exterior surface portion 42 parts of which are seen in this view. The rounded edges of frame 14, and of rear cover 16, improve impact resistance of LCD 10. This is a departure from traditional LCD module frames that are not intended as exterior surfaces of the LCD and that often include unsightly features such as mounting and fastening elements for other components of the LCD. The frame 14 includes a front portion 47 with an interior surface (not shown in this view) that holds the bezel 76, and a rear portion 49 with an interior surface (not shown in this view) that holds the rear cover 16.

The parts of the LCD 10 may be made of any of a variety of suitable materials. The frame 14 may be a metal frame that is primarily made of metal. The metal frame may have a non-metal layer over at least part of an external surface of the frame that forms part of the external surface of the LCD 10. Alternatively the frame 14 may be made of suitable plastic. In the embodiment in which the frame 14 forms all of or a substantial portion of the exterior surface 40 of the LCD 10, a plastic material for the exterior portions of frame 14 may comprise a mixture including a strengthening component such as polyester.

The rear cover 16 may be made of a suitable metal, such as steel or aluminum. The rear cover 16 may have a non-metal layer over at least part of an external surface of the frame that forms part of the external surface of the LCD 10. Other materials are also possible for the rear cover 16, such as an engineering plastic (e.g. acrylonitrile butadiene styrene (ABS) or high impact polystyrene (HIPS)) that is chosen for its rigidity and impact resistance.

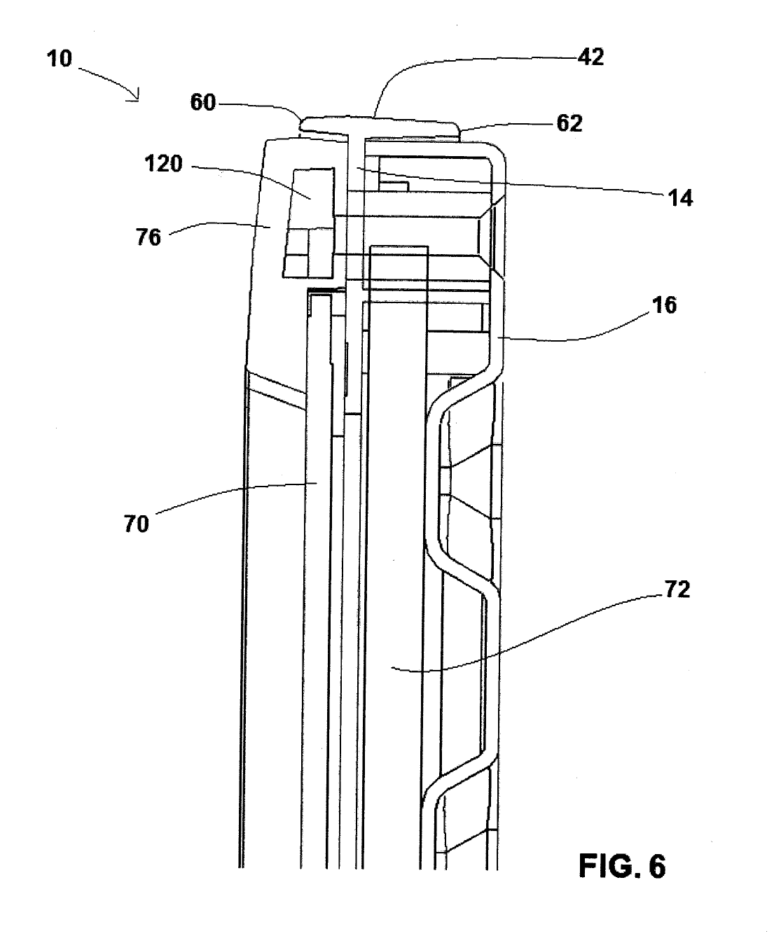

Referring now in addition to FIGS. 6 and 7, some details are shown regarding the mechanical coupling of parts of the LCD 10. FIG. 6 shows the coupling at the top of the LCD 10, and FIG. 7 shows the coupling at the bottom of the LCD 10. The components 12, the cell 70 and the backlight unit 72, are located in a recess 120 in the frame 14. The cell 70 and the backlight unit 72 are sandwiched between the bezel 76 and the rear cover 16. At the bottom of the LCD 10 the bezel 76 has a pair of hooks 122 and 124 that engage the bottoms of the frame 14 and the rear cover 16, respectively. The hooks 122 and 124 may extend across most of the width of the LCD 10. The hook 122 engages a backward-bent bottom flange 128 of the frame 14.

As an alternative, the bezel 76 may be have one or more rearward protrusions that are tucked into an inner surface of the frame 14, in order to engage the frame 14.

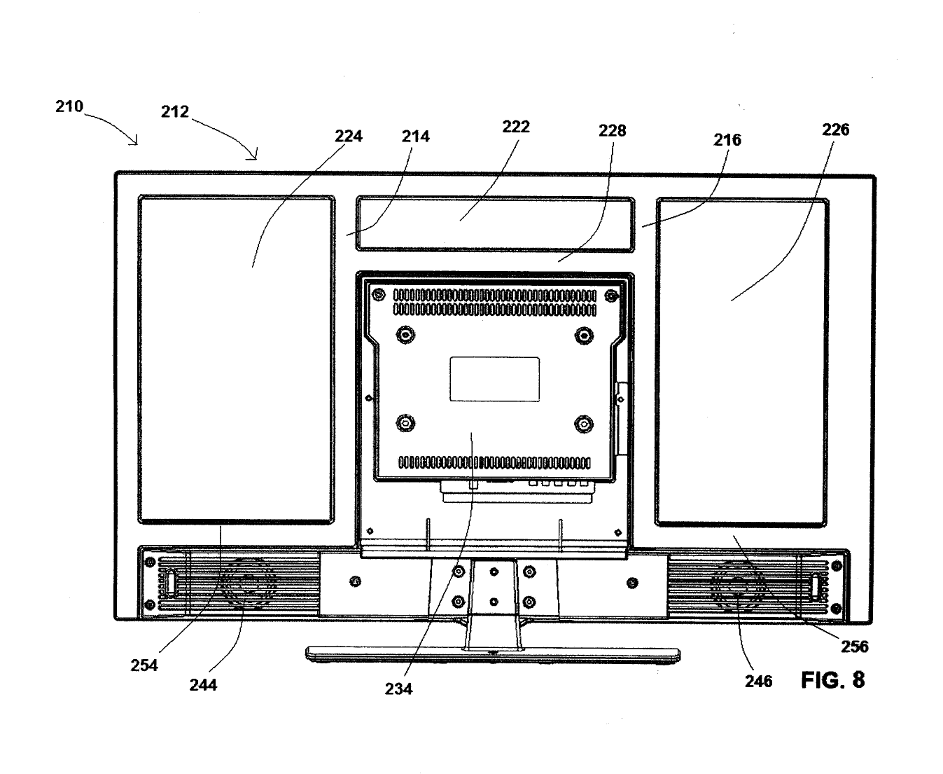

FIGS. 8-11 show configurations of alternate embodiment LCDs, LCDs having different rear cover configurations, for different screen sizes. One advantage of the LCDs described herein is that the same or a similar configuration of main board housing and main board housing cover may be used for LCDs having a range of different sizes. There is no need to use a completely different housing configuration for each size, since a variety of configurations of horizontal and vertical ribs can provide the needed mechanical properties (resistance to bending) depending on the diagonal size of the TV, while sharing a common width of the center portion of the rear cover across these different screen sizes. Larger sized LCDs may include additional horizontal or vertical ribs to increase resistance to bending. In addition, different sized LCDs may include the same number and general configuration of horizontal and vertical ribs, but with substantial differences in location and/or dimensions of the ribs that can affect resistance to bending.

FIG. 8 shows an LCD 210 that has a rear cover 212 with vertical ribs 214 and 216 that extend along parts of the borders between a center portion 222 of the rear cover 212, and side portions 224 and 226 of the rear cover 212. A horizontal rib 228 runs between the ribs 214 and 216, above a main board housing cover 234. Speakers 244 and 246 are at a bottom edge of the LCD 210, at the lower parts of the side portions 224 and 226. Horizontal ribs 254 and 256 are located above the speakers 244 and 246, respectively. In other respects the LCD 210 may be similar to the LCD 10 (FIG. 1).

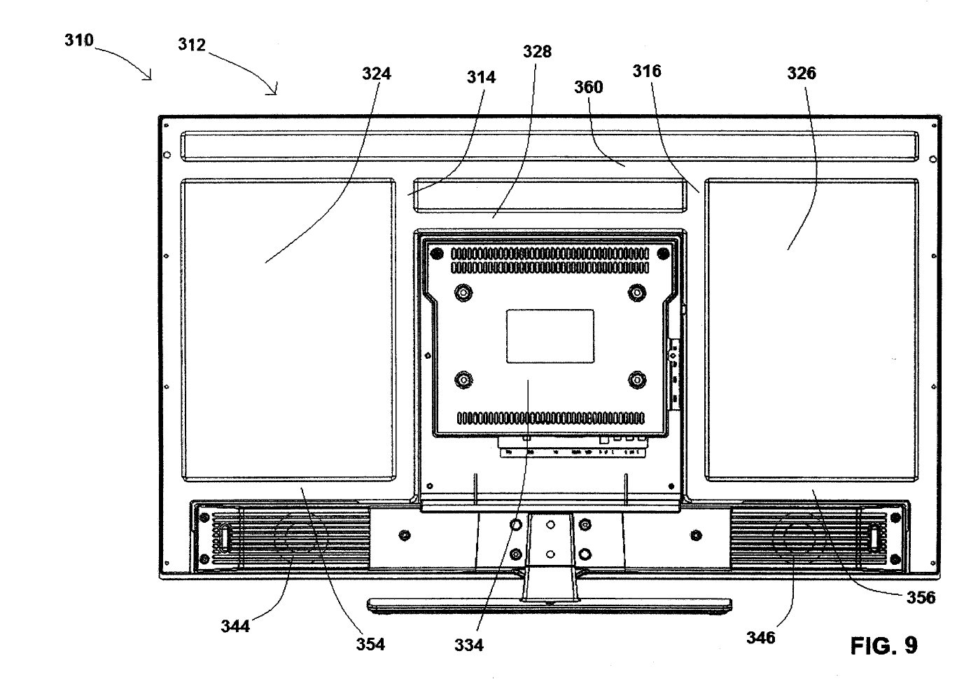

FIG. 9 shows an LCD 310 that has a larger size than LCD 210; the LCD 310 includes more ribs than the LCD 210. The rear cover 312 of the LCD 310 has vertical ribs 314 and 316 that extend along parts of the borders between a center portion 322 of the rear cover 312, and side portions 324 and 326 of the rear cover 312, similar to corresponding ribs of the LCD 210 (FIG. 8). A horizontal rib 328 runs between the ribs 314 and 316, above a main board housing cover 334, similar to a corresponding rib of the LCD 210. The rear cover 312 has horizontal ribs 354 and 356 that are located above the speakers 344 and 346, respectively, similar to corresponding features of the LCD 210. In addition, the rear cover 312 has an additional horizontal rib 360 near the top of the rear cover 312. The rib 360 extends all the way across the width of the rear cover 312.

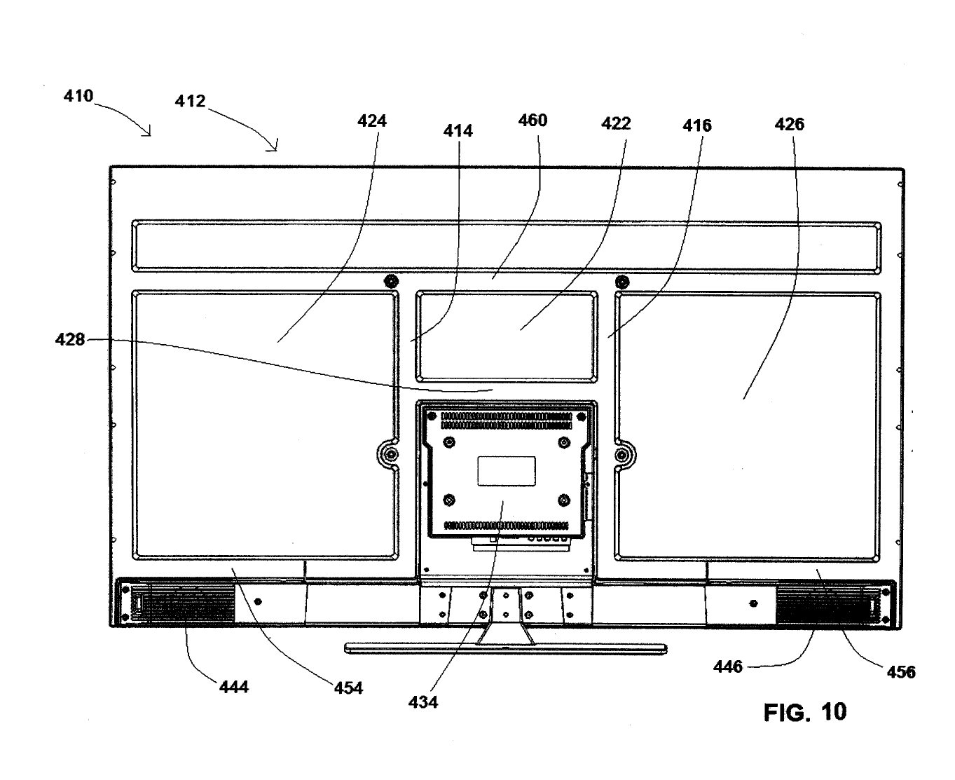

FIG. 10 shows an LCD 410 that has a larger size than the LCD 310. LCD 410 includes the same number and general configuration of horizontal and vertical ribs as LCD 310, but with differences in location and dimensions of the ribs. The vertical ribs 414 and 416 that extend along parts of the borders between a center portion 422 of the rear cover 412, and side portions 424 and 426 of the rear cover 412, are similar to corresponding ribs of the LCD 310 (FIG. 9) but with differences in dimensions of the vertical ribs. A horizontal rib 428 runs between the ribs 414 and 416, above a main board housing cover 434, similar to a corresponding rib of the LCD 210 and of the LCD 310. The rear cover 412 has horizontal ribs 454 and 456 located above the speakers 444 and 446, respectively, and an additional horizontal rib 460 near the top of the rear cover 412. These horizontal ribs are similar to corresponding ribs of the LCD 310 (FIG. 9) with differences in spacing and dimensions appropriate to the larger size of LCD 410.

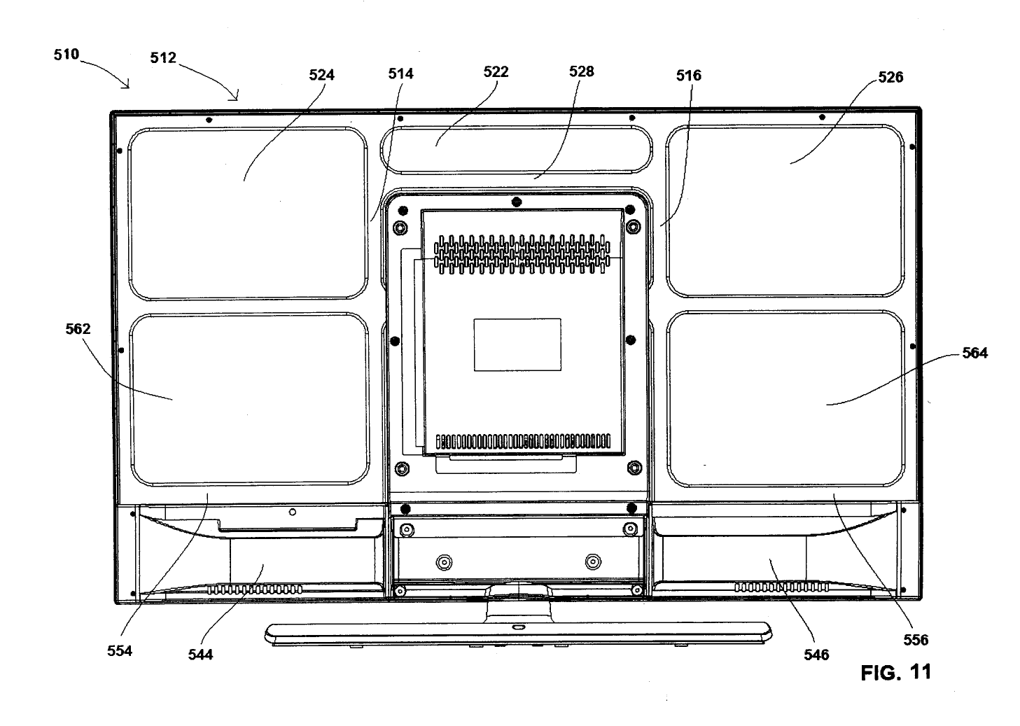

FIG. 11 shows an LCD 510 that has a larger size than LCD 210 (FIG. 8). The LCD 510 includes more ribs than the LCD 210; compare the LCD 310 (FIG. 9), which has a different arrangement of additional ribs. The rear cover 512 of the LCD 510 has vertical ribs 514 and 316 that extend along parts of the borders between a center portion 522 of the rear cover 312, and side portions 524 and 526 of the rear cover 312. The rear cover 512 has horizontal ribs 554 and 556 that are located above the speakers 544 and 546, respectively. In addition, side portions 524 of rear cover 512 and 526 respectively include additional horizontal ribs 562, 564 midway between the horizontal ribs 554, 556 and the top edge of rear cover 512. The LCD 510 includes rounded corners at the intersections of horizontal and vertical ribs.

Although the invention(s) has (have) been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A liquid crystal display (LCD) comprising:
a frame;
components of the LCD that are supported by the frame; and
a rear cover that forms at least part of a back side of the LCD;
wherein at least some of the components are coupled to an inside surface of the frame;
wherein the LCD has a rectangular shape, with a rectangular front face and a rear face;
wherein the LCD has an exterior surface that defines an outer periphery of the rectangular shape, between the front face and the rear face; and
wherein the rear cover is in an interior part of the rectangular shape, such that the exterior surface does not include any part of the rear cover.

2. The LCD of claim 1,
wherein the exterior surface has a top exterior surface portion, a bottom exterior surface portion, and a pair of side exterior surface portions;
wherein the top exterior surface portion and the bottom exterior surface portion are on opposite respective sides of the liquid crystal display in a first direction; and
wherein the side exterior surface portions are on opposite respective sides of the liquid crystal display in a second direction.

3. The LCD of claim 1,
wherein the exterior surface has a front edge at the intersection of the exterior surface and the front face; and
wherein the exterior surface has a rear edge at the intersection of the exterior surface and the rear face.

4. The LCD of claim 3, wherein the frame constitutes at least part of the front edge.

5. The LCD of claim 4, wherein the frame constitutes at least half of the front edge.

6. The LCD of claim 4, wherein the frame constitutes substantially all of the front edge.

7. The LCD of claim 3, wherein the frame constitutes at least part of the rear edge.

8. The LCD of claim 7, wherein the frame constitutes substantially all of the rear edge.

9. The LCD of claim 3, further comprising a bezel that constitutes at least part of the front edge.

10. The LCD of claim 9, wherein the frame constitutes a portion of the exterior surface that is to the rear of the front edge.

11. The LCD of claim 9, wherein the bezel is attached to an inner mounting surface of the frame.

12. The LCD of claim 3,
further comprising a bezel that constitutes at least part of the front face;
wherein the bezel constitutes less than half of the front edge.

13. The LCD of claim 12, wherein the bezel is mounted to the inside surface of the frame.

14. The LCD of claim 1, wherein the components include a cell having display pixels, and a backlight unit.

15. The LCD of claim 1, wherein the frame is a metal frame that is primarily made of metal.

16. The LCD of claim 15, wherein the frame has a non-metal layer over at least part of an external surface of the frame that forms part of the external surface of the LCD.

17. The LCD of claim 1, wherein the frame is a plastic frame.

18. The LCD of claim 1, wherein the rear cover includes strengthening ribs.

19. The LCD of claim 18, wherein the ribs include horizontal ribs.

20. The LCD of claim 18, wherein the ribs include vertical ribs.

21. The LCD of claim 1, wherein the rear cover includes a center portion, and two side portions on opposite sides of the central portion.

22. The LCD of claim 21, wherein the center portion of the rear cover supports a main board housing.

23. The LCD of claim 22, wherein the main board housing is connected to a back face of the center portion, wherein the back face of the center portion faces away from the components.

24. The LCD of claim 22, further comprising a main board housing cover that covers the main board housing and at least part of the center portion.

25. The LCD of claim 21, wherein the side portions support speakers of the LCD.

26. The LCD of claim 25, wherein the speakers are connected to back faces of the side portions, wherein the back faces of the side portions face away from the components.

27. The LCD of claim 1, wherein the frame forms part of the external surface of the LCD, when the display is fully assembled

28. The LCD of claim 1, wherein the rear cover constitutes at least part of the rear face of the LCD.

29. The LCD of claim 28,
wherein the rear cover includes a center portion, and two side portions on opposite sides of the central portion; and
wherein the side portions are substantially uncovered, and therefore part of the exterior rear surface of the LCD.

30. The LCD of claim 1, wherein at least some of the components are inserted into a recess in the inner surface of the frame.

31. A liquid crystal display (LCD) comprising:
a frame;
components of the LCD that are supported by the frame; and
a rear cover that forms at least part of a back side of the LCD;
wherein the rear cover includes a center portion, and two side portions on opposite sides of the central portion;
wherein the rear cover is a structural support that prevents bending of the components; and
wherein the rear cover includes strengthening ribs.

32. The LCD of claim 31, wherein the strengthening ribs are in both the center portion and the side portions.

33. The LCD of claim 32, wherein the strengthening ribs in the center portion include two vertical ribs at the boundaries between the center portion and the side portions.

34. The LCD of claim 32, wherein the center portion supports a main board housing of the LCD.

35. The LCD of claim 34, wherein the main board housing is connected to a back face of the center portion, wherein the back face of the center portion faces away from the components.

36. The LCD of claim 34, further comprising a main board housing cover that covers the main board housing and at least part of the center portion.

37. The LCD of claim 32, wherein the side portions supports speakers of the LCD.

38. The LCD of claim 37, wherein the speakers are connected to back faces of the side portions, wherein the back faces of the side portions face away from the components.

39. The LCD of claim 31, wherein the side portions are symmetric, on opposite sides of the center portion.

40. The LCD of claim 39, wherein the center portion has a width of between 20% and 60% of an overall combined width of the center portion and the side portions.

41. A liquid crystal display (LCD) comprising:
a frame;
components of the LCD that are supported by the frame; and
a rear cover that forms at least part of a back side of the LCD;
wherein the rear cover includes a center portion, and two side portions on opposite sides of the central portion;
wherein the rear cover is a structural support the prevents bending of the components; and
wherein the side portions are substantially uncovered, and therefore part of an exterior rear surface of the LCD.

42. The LCD of claim 41, wherein the components include a cell and backlight unit of an LCD module, and the rear cover comprises a cover of the LCD module.

43. The LCD of claim 41, wherein the center portion supports a main board housing of the LCD.

44. The LCD of claim 43, wherein the main board housing is connected to a back face of the center portion, wherein the back face of the center portion faces away from the components.

45. The LCD of claim 44, further comprising a main board housing cover that covers the main board housing and at least part of the center portion.

46. The LCD of claim 41, wherein the side portions supports speakers of the LCD.

47. The LCD of claim 46, wherein the speakers are connected to back faces of the side portions, wherein the back faces of the side portions face away from the components.

48. The LCD of claim 47, wherein the back faces of the side portions are uncovered except where the speakers are connected to the side portions.

49. The LCD of claim 41, wherein the rear cover is made of metal.

50. The LCD of claim 41, wherein the rear cover is made of plastic.

51. The LCD of claim 41, wherein the rear cover has strengthening ribs.

52. The LCD of claim 51, wherein the strengthening ribs includes ribs at boundaries between the center portion and the side portions.

53. The LCD of claim 52, wherein the ribs at the boundaries are vertical ribs.

54. The LCD of claim 51, wherein the ribs have smooth, continuous outer surfaces.

55. The LCD of claim 51, wherein the ribs have rounded edges.

56. The LCD of claim 41, wherein the side portions are symmetric, on opposite sides of the center portion.

57. The LCD of claim 56, wherein the center portion has a width of between 20% and 60% of an overall combined width of the center portion and the side portions.
